(19) United States
(12) Patent Application Publication
(10) Pub. No.: US 2026/0016317 A1
(43) Pub. Date: Jan. 15, 2026

(54) ASSIGNING AN ATTRIBUTE TO GRID ELEMENTS OF A GLOBAL REFERENCE GRID NETWORK THAT OVERLAP WITH A VECTOR OBJECT

(71) Applicant: THE GREEN BRIDGE INGENIEURGESELLSCHAFT MBH, Geretsried (DE)

(72) Inventor: Roman BRYLKA, Wolfratshausen (DE)

(21) Appl. No.: 19/280,565

(22) Filed: Jul. 25, 2025

Related U.S. Application Data
(63) Continuation of application No. PCT/EP2024/052184, filed on Jan. 30, 2024.

(30) Foreign Application Priority Data
Feb. 2, 2023 (DE) 10 2023 102 618.6

(51) Int. Cl. G01C 21/00

(52) U.S. Cl. CPC G01C 21/3867

(57) ABSTRACT

A method detects a spatial arrangement of a physical object by assigning an attribute to a selection of uniquely identifiable global grid elements of a reference grid network. The method includes providing a global reference grid network with a geographical reference point defined vector-object-independently and global grid elements, which are adjacent to one another without overlap and are uniquely identifiable within the global reference grid network and are georeferenced with regard to a provided reference coordinate system, providing a vector object with at least one vertex, to which a geographical coordinate of the geographical reference coordinate system is assigned, determining and selecting those global grid elements that overlap with the vector object, and assigning an object attribute linked with the vector object or a further attribute to the grid elements selected and storing the selected grid elements with assigned attributes.

### CROSS REFERENCE TO RELATED APPLICATIONS

This application is a continuation of International Patent Application No. PCT/EP2024/052184, filed on Jan. 30, 2024, which claims priority to German Patent Application No. 10 2023 102 618.6, filed Feb. 2, 2023, the contents of each of which are incorporated by reference herein.

### FIELD OF THE INVENTION

The present invention relates to a computer-implemented method for capturing a spatial arrangement of a physical object on a physical surface within a reference coordinate system by assigning an object attribute and/or further attribute to a selection, determined by means of a vector object, of uniquely identifiable grid elements of a global reference grid, in particular within a database of a GIS application, a BIM application or a machine control application.

### BACKGROUND

A GIS application, also known as a geo information system application or geographic information system application, is an application of a computer-aided information system for capturing, processing, organizing and analyzing spatial data.

A BIM application, also known as a building information model application, is an application of a computer-aided information system for the planning, construction and management of a building or structure.

A machine control application can itself have a GIS or BIM application and is used to control or navigate mobile machines on a surface or in space on the basis of surface or spatial data.

In both GIS applications and BIM applications, an object (fixed or mobile, real or planned), an area or a structure can typically be mapped in its geographical position and extent using a vector graphic (also known as a vector object).

A vector object (or vector graphic) is an image file whose content is defined by mathematical descriptions or calculations. Unlike raster graphics (raster data, raster data set), the individual pixels of the image are not assigned a pixel value (representing a grey or color level) and stored; instead, a (mathematical) description of all elements in the image is stored.

In this system, for example, a circle is described by a defined number of points that lie on the circumference of a circle and are connected by point-to-point lines.

Both raster graphics and vector objects are usually used in GIS applications. For example, a satellite image of a certain region can be available as a raster graphic (raster dataset), while the course of the roads in this region is available as a vector object. With the help of GIS applications, the raster graphic and the vector object can be “superimposed” and overlaid in order to link their information content. US 2007 014 488 A1 describes a method of how such a congruent overlay can be carried out using characteristic landmarks (e.g. an intersection), which can be easily determined both in the raster graphic and in the vector object. However, the information contained in the vector object about the position and nature of the physical object depicted is not transferred to a higher-level global grid, but merely superimposed on the raster graphic with the vector object.

A vector object in the present sense describes in particular (at least) one point, (at least) one line, (at least) one polygon, (at least) one surface and/or (at least) one (three-dimensional) body, and has (at least one) support point, each of which is assigned a unique position in a geographical reference coordinate system and which together represent the position and extent of the depicted object, the depicted surface or the depicted structure in the reference coordinate system.

The individual support points—and therefore also the associated vector object—are georeferenced within the reference coordinate system. In this context, this refers to the assignment of spatial information to a data set to create a spatial reference within the reference coordinate system.

Within a GIS or BIM application, for example, a plot of a property (e.g. school grounds), a building (e.g. school building), a part of a building (e.g. assembly hall) or an individual component (e.g. foundation, first floor ceiling, PV module on roof) can each be recorded as a separate vector object.

In common GIS applications, spatial information of physical objects (or structures) arranged in physical space is stored in databases by creating a vector object representing this physical object (or structure) for each physical object (or structure). This is done by creating a vector object for each physical object (or structure) with a separate data record that links, for example, an object identification number, an object type (e.g. point, line, polygon), one or more coordinate points, an object type (e.g. tree, street, building) and other attributes (e.g. tree type, street name). This is typically done in a database management system with a relational database structure.

It is often desirable to subdivide the vector object into smaller units so that specific properties (attributes) can be assigned to individual sub-areas of the mapped physical object (or the mapped physical area, the mapped physical structure); for example, if contaminated sites are only recorded on part of a property area described as a vector object.

For this purpose, common GIS applications (e.g. the QGIS program) and common BIM applications can generate an associated local grid (also known as a grid) for a vector object. A grid typically comprises a large number of regularly arranged grid elements (e.g. points, lines, circles, polygons, polyhedrons) that cover the vector object in terms of its size and position in the reference coordinate system. Such grids are typically two-dimensional.

In addition, further attributes can be assigned to each grid element in order to capture grid element-specific properties (such as temperature values, material thickness, measured values or material type).

The extent of the individual grid elements (i.e. the grid width in the various spatial directions) can typically be defined by the user depending on the specific task and can be 500 m×500 m or 1 mm×1 mm for a two-dimensional grid, for example.

The starting point for generating the local grid (also called the reference point of the grid) is typically generated automatically and depends on the extent and position of the associated vector object for which the local grid is generated. It has become established in common GIS and BIM applications that the intersection of the northernmost and westernmost coordinate values (in relation to a reference coordinate system) of the respective vector object is selected as the reference point. The reference point is therefore “top left” of the corresponding vector object. Starting from this reference point, a local grid is then spanned according to the user specifications for the grid width. Attributes can be assigned to the (local) grid elements created in the process. In this way, properties can be captured not only at the level of the (entire) vector object, but also much more granularly and in greater detail at the level of the individual grid elements.

With regard to the database structure, a vector object-specific, local grid with the assigned attributes for the individual grid elements is typically saved as a further data set in common GIS applications. The grid elements are each separate, independent vector objects. The corner points of the grid elements are each assigned a coordinate in the coordinate system. The position and arrangement of the local grid and the (local) grid elements is therefore dependent on the position and size of the vector object from which the local grid was derived.

Against this background, such grids are also referred to in this publication as “local” grids and the associated grid elements as “local” grid elements. Typically, there are neither relations between the individual local grid elements themselves, nor relations between the grid elements and the vector object from which the vector object specific local grid was derived. The grid elements are only linked to each other, i.e. to form a grid, if they are stored in the same data table.

The video available at https://www.youtube.com/watch?v=aGNMRTgw3c8 entitled “QGIS 3—Gitter-und Punktnetze erstellen|QGIS Tutorial|Deutsch|German” (English translation of the video title: “QGIS 3—Create grid and point meshes|QGIS Tutorial|German”) explains the creation of such a local grid in the common GIS application QGIS as an example. FIG. 1 shows a screenshot of the video to illustrate the state of the art. FIG. 1 shows a section of a georeferenced map 1 with a lake 2 at its center. The shoreline of lake 2 is shown as a georeferenced polygon vector object 3. The polygon vector object 3 has a large number of support points that are connected by polygon edges and thus describe the contour of the shoreline of lake 2. The interior of the polygon (i.e. the area between the polygon edges) represents the water surface of lake 2. Furthermore, a local grid 4 can be seen, which covers the polygon vector object 3. The local grid 4 was generated according to the method commonly used in the state of the art, outlined above. The reference point 5 of the local grid 4 lies at the intersection of the northernmost coordinate value of the polygon vector object 3 (see horizontal straight line 6) and the western coordinate value of the polygon vector object 3 (see vertical straight line 7). Based on this reference point 5, which obviously depends on the position and dimensions of the polygon vector object 3, the corresponding local grid 4 was generated. The reference point 5 thus forms the “top left corner” of the local grid 4. The local grid 4 comprises a large number of similar quadrangular grid elements 8 that are adjacent to each other. The size of the local grid 4 is selected so that it completely covers the polygon vector object 3. In the next step, an attribute (such as a temperature value or a water depth) could be assigned to all or individual grid elements 8. The size and position of the local grid 4 and the number and position of the grid elements 8 depend directly on the size and position of the polygon vector object 3.

If, for example, a grid with its own grid elements is created for two overlapping vector objects, these two local grids (grids) together with their grid elements and the attributes linked to them are completely independent of each other. This means that there is no link between the grid elements of the different grids. The two grids with their own independent grid elements therefore represent isolated data spaces with individual vector objects, between which there are basically no cross-references. Linking the grid elements of different local grids is further complicated by the fact that the grid elements of the different local grids have different reference points and are therefore typically not congruent with each other.

The following example for two overlapping vector objects is intended to provide clarification: A first local grid is created for the first vector object and a first attribute is assigned to some of the first grid elements. Similarly, a second local grid is created for the second vector object and a second attribute is assigned to some of the second grid elements. There is no link between the first grid elements and the second grid elements, even if they partially overlap. The information on the first attribute and the second attribute is therefore located in different local grids (and therefore in different data spaces) and cannot be linked consistently (or only with a great deal of effort).

The creation of grids and the assignment of attributes to individual grid elements also plays a role in connection with the navigation and control of autonomous vehicles. U.S. Pat. No. 2,020,293 038 A1 describes a method for determining a driving route in a parking lot. The starting point is a georeferenced satellite image of the parking lot (see FIG. 5A) and therefore a raster graphic (raster data set) and not a vector object. In order to determine which areas of the parking lot can be driven on and which cannot (e.g. because there is a kerb, a tree or a building), the satellite image is overlaid with a local grid (see FIGS. 5A and 5B) and image recognition is used to determine for each grid element whether the associated area can be driven on or not. On this basis, the individual grid elements are assigned the attribute “navigable area” or “static obstacle” and a route is defined that only crosses navigable grid elements. The positions of the grid elements are obviously determined by the layout of the satellite image, as the local grid (grid 5100) runs flush with the edges of the satellite image as shown in FIG. 5A. The grid and with it the grid elements are thus positioned and defined locally depending on the satellite image, the raster data set. Accordingly, it is a local grid with local grid elements.

CN 114 445 517 A describes a method for indoor navigation, i.e. for planning a route within a building. Here, raster data sets are used which depict the interior of the building in two dimensions. The pixels of the raster data set represent spatial features of the building interior and are each assigned to a coordinate (see paragraph [0052]). The positions of the pixels are therefore defined locally, depending on the section of the building interior shown in the raster dataset.

Due to this “isolation” of the local grids of different vector objects, conventional GIS and BIM applications cannot be used (or can only be used with great effort) to deal with the following technical problems of surface or building planning and machine control:

### 1) Tracking or Planning Changes to Surfaces, Especially if the Changes Only Partially Affect a Vector Object.

For this purpose, the grid containing the grid elements with the attribute to be changed must first be laboriously identified and selected from the large number of different grids.

### 2) Tracking and Planning Changes to Surfaces if the Change Only Affects Parts of a Grid Element.

If smaller grid elements would be useful later on in order to capture properties or attributes, this cannot be realized or can only be realized with great effort. This is because if a new grid with smaller grid elements were to be created, these smaller grid elements would have no reference to the larger grid elements created earlier according to the state of the art. And if grids with very small grid elements are created from the outset as a precaution, this leads to very large files, which greatly increases the effort required to store and process the data.

Accurate and up-to-date surface information (see points 1) and 2)) can serve in particular as a basis for the precise control of mobile machines.

### 3) the (Forgery-Proof) Mapping and Documentation of Shifts of Material or Volumes on Surfaces

In view of the growing importance of the circular economy, there is a need to map, capture and document material flows in terms of volume, type and time (even beyond a construction site) in order to ensure efficient and correct reuse or disposal and to prevent or impede recycling fraud and illegal waste disposal.

The aim here is to track the whereabouts and history of materials across different types of condition. Existing BIM and GIS applications are not suitable for this (or only to a very limited extent), although high-resolution material data is often available via vector objects and their grids.

For example, if it is recorded in a typical GIS or BIM application that a certain wall of a building is contaminated with asbestos by assigning a corresponding attribute to the associated vector object “wall” (or the grid elements of a grid created for the vector object), this material information cannot typically be linked to the material that is produced when this wall is demolished and leaves the construction site. The material information is to a certain extent linked to the vector object or the associated grid and can no longer be used meaningfully if the (real) object depicted (in this example, the wall) no longer exists in this structure.

### 4) Detecting (Area) Usage Conflicts

Conflicts in land use are difficult to detect in conventional GIS and BIM applications, because even if the grid elements of two local grids overlap and conflicting attributes are assigned to the two overlapping grid elements, this conflict is difficult to detect in the state of the art, as the two grid elements belong to different, isolated local grids (or data spaces).

### 5) Detection of Free Areas or Corridors (Detection of NON-Intersections)

For numerous technical applications, especially in connection with the control of moving machines, it is necessary to determine an area or corridor that is free of obstacles (or objects) so that the machine can drive or fly over it (free corridor). In the state of the art, with conventional GIS and BIM applications, this is only possible with great effort and with the aid of complex and time-consuming mathematical calculations due to the structure of the available data.

### SUMMARY

The present disclosure is based on the task of overcoming the aforementioned weaknesses of the prior art, in particular in BIM or GIS applications, and in particular of enabling machine control applications. In particular, it is a task of the disclosure to provide a computer-implemented method (for a database management system), in particular within a GIS application, a BIM application or an application for machine control, which makes it possible to capture the spatial arrangement of physical objects or structures on physical surfaces (or in physical space) and to document changes, to capture and document material displacements in relation to volume, material type and time and to detect potential conflicts of use, while achieving the highest degree of data consistency and using only a small amount of memory. Furthermore, the disclosure is intended to create the basis for greatly reducing the complexity and thus the energy consumption of subsequent data processing, which are decisive factors in connection with the control of machines.

This task is solved by the computer-implemented method for capturing a spatial arrangement of a physical object (or a physical structure) on a physical surface (or in physical space) within a geographical reference coordinate system by assigning an object attribute and/or a further attribute to a selection of uniquely identifiable grid elements of a global reference grid determined by means of a vector object, in particular within (a database of) a GIS application, a BIM application or a machine control application, a data processing system, and the computer program product.

The computer-implemented method for capturing a spatial arrangement of a physical object (or structure) on a physical surface (or in physical space) within a geographic reference coordinate system by assigning an object attribute and/or further attribute to a selection of uniquely identifiable grid elements of a (global) reference grid, determined by means of a vector object, in particular within (a database of) a GIS application or a BIM application or a machine control application, comprises the following steps:
A) Providing the (single) global reference grid, georeferenced with respect to the geographic reference coordinate system, with a geographic global reference point defined independently of the vector object and (global) grid elements of a first grid width, which are each formed as a polygon (in particular as a triangular, quadrangular or polygonal grid element), polygon) or as a polyhedron (in particular as an octagonal and six-sided polyhedron), adjoin one another without overlapping and are uniquely identifiable within the global reference grid and are georeferenced with respect to the reference coordinate system, in a storage unit,
B) providing the vector object with at least one support point, to which a geographical coordinate of the geographical reference coordinate system is assigned in each case and which represents the position of an object in the geographical reference coordinate system, in the storage unit,
C) determining and selecting those (global) grid elements of the first grid width which overlap with the vector object by means of a processor unit, and
D) assigning an object attribute linked to the vector object and/or a further attribute to the (global) grid elements of the first grid width selected in step C) by the processor unit and storing the selected (global) grid elements together with the respectively assigned object attribute and/or the further attribute in the storage unit.

This method of assigning an object attribute (or a further attribute) to the selection of (global) grid elements determined by means of the vector object makes it possible to solve the technical problems mentioned above in a surprising way. This is because, according to the disclosure, attributes are not captured and stored in various local grids (as has been customary in the prior art up to now), which were generated for various vector objects as separate tables, in the best case relationally linked to the respective vector object, and which form isolated data spaces whose data cannot (or can only with difficulty) be linked to one another; but all object attributes (and other attributes) linked to the various vector objects are captured and stored in a single global reference grid with uniquely identifiable global grid elements by assigning the respective object attribute (or other attribute) to the global grid elements overlapping with the respective vector object. All object attributes (and other attributes) are thus available in a common georeferenced global grid (or data space) within a database (or several linked databases). Changes to individual attributes (and their validity) can be captured easily and consistently in this way.

For this purpose, the global reference grid and (therefore also) the global grid elements are defined in relation to a vector object-independent geographical reference point. Instead of generating a separate local grid for each vector object and linking it to the object attributes, the attributes of all vector objects are captured using a single global reference grid and the same global grid elements and stored in a database or data store.

To express the fact that the grid elements of the global reference grid are assigned to it and are defined as globally unique and vector object-independent, they are also referred to as “global grid elements” in the context of this publication.

The position and arrangement of the global reference grid is determined by the vector-object-independent geographical reference point and is thus expressly not dependent on the position and size of the object to be captured. The method described thus differs fundamentally from the methods commonly used in the prior art, as described in the documents U.S. Pat. No. 2,020,293 038 A1 or CN 114 445 517 A for navigation applications. There, the position of the grid, the grid elements or the pixels is determined by the image section depicted in the respective raster data set and is therefore dependent on the object to be captured. Accordingly, local grids and local grid elements are described in the aforementioned documents.

The method thus relates to features that concern the internal functioning of the database or the database management system. This is because the use of the global, georeferenced reference grid with georeferenced global and unique grid elements in defines the structure of the underlying database and, with it, the internal functioning of the database management system. The global and unique grid elements act as geospatial unique identifiers.

Embodiments of the invention thus solve the technical problem of efficiently capturing and processing spatial data of physical objects or structures arranged on a physical surface (or in a physical space) by means of the data structure defined by the method in which this spatial data is stored and managed in the database.

The data structure defined by the method and the associated type of data management enables extremely memory-efficient, computationally efficient and thus resource-efficient capturing, management and further processing of spatial data, which can be particularly advantageous in connection with the control of machines.

Furthermore, the method has a direct reference to physical surfaces, spaces or objects and thus to physical reality due to the georeferenced reference of the global reference grid and the global grid elements.

One or more object attributes and/or one or more further attributes can be assigned to each global grid element of the global reference grid. An object attribute is linked to a vector object in each case. A further attribute is linked to (at least) one (further) characteristic.

The attribute assignments are therefore all located in the common data space of the single global reference grid. Cross-relationships between the individual attributes and the individual global grid elements, even if they are based on different vector objects, can therefore be easily established. The attribute assignments can be used consistently beyond the respective original vector object.

This represents a radical departure from the methods previously used in GIS and BIM applications, where a separate local grid with its own local grid elements is typically created for each vector object (or group of vector objects) and thus the attribute information of the local grid elements of each vector object is available in its own isolated, locally defined data space. Cross-relationships between the locally referenced data spaces cannot be created there (or only with great difficulty and with the acceptance of inconsistencies).

The method, on the other hand, makes it possible to consistently and easily capture, retrieve and manage the status of or changes to a surface or volume. The surface area (or volume area) to which a special attribute is to be assigned can be described or mapped using a vector object. According to the above method, the corresponding attribute is then assigned to the global grid elements of the global reference grid selected (using the vector object). This procedure can be repeated as often as required for different vector objects and different (object) attributes, but the attributes are always assigned to global grid elements that are located in one and the same global reference grid.

The global reference grid can be used in conjunction with several different geographical reference coordinate systems. For example, it is possible for a first vector object to be defined in relation to a first geographic reference coordinate system (e.g. the WPM World Pseudo Mercator reference coordinate system) and a second vector object to be defined in relation to a second geographic reference coordinate system (e.g. the WGS84 reference coordinate system). The position of the global reference point of the global reference grid is defined both in the first reference coordinate system and in the second reference coordinate system. Regardless of whether a vector object is defined in the first or second reference coordinate system, its position on the physical surface can be consistently captured in the global reference grid.

A vector object can be provided, for example, by loading a vector graphics file (e.g. in the relevant GIS or BIM application or machine control application). Alternatively, a vector object can be created via a GUI (graphical user interface) in a map view using an input device (e.g. mouse or touch screen) by selecting grid elements or drawing a selection window (box) and thus making a selection of grid elements. A vector object can also be provided as a list of individual points.

In the prior art, however, a new, independent local grid is generated for each vector object or a group of vector objects, the local grid elements of which have no reference to the local grid elements of the other local grids.

The entire attribute information is stored in a single, common (global) data space. Cross-references and links can be easily created, and changes to the attribute values for individual global grid elements can be made without any problems.

Furthermore, the method makes it possible to save memory space. This is because when capturing a vector object, not all possible local grid elements of a local grid need to be generated and stored and then assigned an attribute value (or a zero value), but only those global grid elements of the global reference grid that overlap with the vector object and to which an attribute is assigned. To a certain extent, only those global grid elements of the global reference grid are stored with attribute information that are required to capture the vector object because they overlap with it. In this way, the number of global grid elements to be stored can be radically reduced if the many global grid elements that do not overlap the vector object or to which no attributes are assigned are not taken into account and stored at all.

Furthermore, the method makes it possible to assign a (point-like) vector object to the respective overlapping global grid element (of the vector object) of the reference grid. In this way, (point-like) location information (e.g. relating to the current position of a mobile telephone) can be aggregated and clustered by assigning a corresponding attribute to the grid element in which the respective location is located.

The global grid elements of the global reference grid can thus also assume the role of a global and spatially unique identifier as a geo-referenced data equivalent.

The method can be used in both two-dimensional (2D) and three-dimensional (3D) coordinate systems in order to process 2D or 3D vector objects. For this purpose, the global reference grid is designed as a two-dimensional or three-dimensional global grid.

Some further aspects of the method are explained in more detail below:

The reference point of the global reference grid is georeferenced with respect to the reference coordinate system and is defined independently of the vector object (or vector objects) to be captured (vector object-independent defined reference point). This means that the reference point is not redefined (vector-object-specific) as a function of the size and position of the vector object each time a new local grid is generated for a vector object, as in the prior art, but that the global reference point no longer changes its position relative to the reference coordinate system once it has been defined-regardless of the size and position of the vector object to be captured.

The term (single) global reference grid expresses the fact that the one reference grid covers the entire geographical reference coordinate system. A geographical reference coordinate system can represent an entire planet or, in particular, only a selected region (e.g. Europe, Africa, North America) or a selected country. In conjunction with the coordinates of the reference point, a global reference grid can be generated in this way, in which the coordinates of the individual corner points of the uniquely identifiable global grid elements in the reference coordinate system can be clearly determined algorithmically.

The following exemplary explanations are intended to illustrate this further with reference to FIG. 2: FIG. 2 shows a two-dimensional reference coordinate system 9 with an x-axis x and a y-axis y. The reference point 10 of a reference grid 11 was defined at the coordinate (0;0) of the reference coordinate system 9. The first grid width is 1 in both spatial directions (i.e. in the x and y directions). The resulting global reference grid 11 with its global grid elements 12 (16 shown) covers the entire reference coordinate system 9. The square grid elements 12 can be uniquely identified by their respective designation E(a;b). Furthermore, their relative arrangement to each other can also be derived from the designation of the grid elements, e.g. the grid element with the designation (1;1) is to the left of the grid element with the designation (2;1) and below the grid element (1;2). This means that the coordinates of the reference point 10, the first grid width (in both spatial directions) and the designation of the grid elements 12 can be used to algorithmically determine the respective coordinates of the corner points 13 of the grid elements. The position of a grid element 12 with respect to the reference coordinate system 9 results from the position of its corner points 13. In a two-dimensional reference coordinate system, each grid element thus represents an associated surface area within the reference coordinate system. In a three-dimensional reference coordinate system with a three-dimensional reference grid, on the other hand, the three-dimensional grid elements each represent a volume area within the three-dimensional reference coordinate system.

A grid element overlaps a vector object if the support points of the vector object and/or a connecting line of the support points lie (at least partially) in an area of the reference coordinate system that the grid element covers. A grid element that extends completely within the polygon edges of the vector object with respect to the reference coordinate system (internal grid element) also overlaps the associated polygon vector object.

The (first) grid width of the global grid elements is determined by the respective extension of the grid elements in the two (2D) or three (3D) spatial directions. The grid elements of a grid width each have an identical grid width.

The technical applications made possible by the method become particularly clear in the advantageous embodiments of the method described herein.

According to a preferred embodiment of the method, it is provided that
a route for a mobile machine is determinable which leads (exclusively) through surface areas or volume areas of the reference coordinate system which are represented by one of the (global) grid elements stored together with the respectively assigned object attribute and/or the further attribute, the route is transmittable to the mobile machine and the route is followable by the mobile machine, and/or
a route for a mobile machine is determinable which leads to a surface area or volume area of the reference coordinate system which is represented by one of the (global) grid elements stored together with the respectively assigned object attribute and/or the further attribute, the route is transmittable to the mobile machine and the route is followable by the mobile machine.

In this way, a mobile machine can be controlled on the basis of the information contained in the attribute assignment regarding the status of a surface/volume area (or global grid element). This can be realized, for example, by determining and transmitting a route to the mobile machine for tracking, which leads (exclusively) over surface areas or volume areas of the reference coordinate system (or global grid elements) to which a defined attribute is assigned. Alternatively, it is also conceivable that routes are defined in such a way that surface areas or volume areas of the reference coordinate system (or global grid elements) to which a certain attribute is assigned are avoided.

A mobile machine can be a vehicle in the air, on water or on land. A mobile machine can, for example, be designed as
an (autonomous) demining vehicle that is sent a route to follow for demining, which passes through areas represented by global grid elements, each of which is assigned the “to be cleared” attribute,
an (autonomous or human-guided) (military) transport vehicle to which a route for following is transmitted that leads exclusively through areas represented by global grid elements, each of which is assigned the attribute “cleared and safe”,
an (autonomous or human-guided) mining machine which is suitable for mining mineral resources in an open-cast mine and to which a route for following is transmitted which leads to an area represented by global grid elements to which the attribute “ready for mining” is assigned,
an (autonomous or human-guided) unloading vehicle that is suitable for unloading landfill material from a landfill site and to which a route for following is transmitted that leads to an area that is represented by a global grid element to which the attribute “ready to receive” is assigned,
an airplane that can be given a route to follow, which leads exclusively through volume areas that are represented by a global grid element, each of which is assigned the attribute “free”.

Furthermore, it can be provided that an alarm signal is triggerable when a mobile machine is located in a surface area or volume area of the reference coordinate system that is represented by one of the global grid elements stored together with the respectively assigned object attribute and/or the further attribute. The alarm can be triggered in particular when the mobile machine enters such a surface or volume area.

According to a further preferred embodiment of the method, it is provided that
the georeferenced global reference grid has grid elements of the first grid width and grid elements of a larger grid width,
the larger grid width is larger than the first grid width and in each case a plurality of grid elements of the first grid width (child grid elements) is assigned to a grid element of the larger grid width (parent grid element) in a uniquely identifiable and georeferenced manner and fills this grid element completely and without overlap, and
the method step C) of determining and selecting those grid elements of the first grid width which overlap with the vector object comprises:
determining and selecting those grid elements of the larger grid width which overlap with the vector object,
activating the grid elements of the first grid width that lie within a grid element of the larger grid width selected in the previous step, and
determining and selecting those grid elements of the first grid width activated in the preceding step which overlap with the vector object.

In this way, a method with particularly high efficiency can be realized, since not all grid elements of the first grid width are checked to see whether they overlap with the vector object, but only those that lie within a grid element of the larger grid width that overlaps with the vector object. This “zooming in” or “drilling down” can massively reduce the number of grid elements to be checked for overlap and therefore the computing time required. It is particularly advantageous if not only grid elements of two different grid widths (first grid width and larger grid width) are used in this “drill-down”. It is immediately apparent to the skilled person that the method can be transferred in an analogous manner to a reference grid which comprises grid elements with more than three different grid widths.

It is conceivable, for example, that the global reference grid comprises grid elements of nine different grid widths. In a two-dimensional reference grid, the grid elements of the largest grid width have a grid width of 100 km×100 km, for example, while the grid elements of the next smallest grid width are each smaller in length and width by a factor of 10. The grid widths of the smaller grid elements are therefore 10 km×10 km, 1 km×1 km, 100 m×100 m, 10 m×10 m, 1 m×1 m, 100 mm×100 mm, 10 mm×10 mm or 1 mm×1 mm. One hundred grid elements of the next smaller grid width fill one grid element of the next larger grid width completely and without overlap and are uniquely identifiable and georeferenced to it. In a three-dimensional reference grid, on the other hand, the individual grid elements would be cube-shaped in the same way, whereby the next smaller grid width would be smaller by a factor of 10 in length, width and height. Thus, 10,000 grid elements of the next smaller grid width would completely fill one grid element of the next larger grid width without overlapping and would be uniquely identifiable and georeferenced to it.

In this embodiment of the method, the coordinates of the respective corner points of the grid elements of the larger grid width can first be determined (algorithmically). In the next step, those grid elements of the larger grid width can then be determined and selected which overlap with the vector object with regard to their position (determined by the respective corner points) in the reference coordinate system. Then (only) those grid elements of the first grid width that lie within the selected grid elements of the larger grid width are activated. For the activated grid elements of the first grid width, the coordinates of their respective corner points can then be determined (algorithmically) and those activated grid elements of the first grid width can be determined and selected which overlap with the vector object with regard to their position (determined by the respective corner points) in the reference coordinate system.

According to a preferred embodiment the at least one further attribute is formed as
a main object attribute that assigns a superordinate main object to a grid element, in particular a building, a storey, a part of a building, a building section and/or a room,
an area attribute that assigns an area name, an area type, an area status and/or an area type to a grid element,
a sub-object attribute that assigns a downstream sub-object to a grid element,
a qualitative or quantitative attribute that assigns a color, a material, a floor type and/or a floor covering type to a grid element,
a temporal or statistical attribute that assigns a time and/or an object number to a grid element, in particular to enable the tracking of moving objects such as vehicles,
a complex attribute that assigns a document, in particular a soil survey, a laboratory analysis or an aerial photograph, and/or a data record, in particular a table, to a grid element, and/or
a link attribute that assigns a link (in particular to a storage location, an IP address or a web address) to a grid element.

Such attributes can be used in particular in BIM and GIS applications as well as machine control applications.

According to a further advantageous embodiment, the vector object is provided by assigning the geographical coordinate of the reference coordinate system to the at least one support point by means of a GPS tracker.

A GPS tracker is a portable device that is set up to capture and document its GPS location. A GPS tracker can be used in conjunction with the method to capture the status of an area, for example, in a particularly simple way. For this purpose, the area to be mapped is “circled” with the GPS tracker. A number of support points are defined and a corresponding polygon vector object is generated. The generated polygon vector object can then be captured according to the method by assigning an associated object attribute (or further attribute) expressing a certain status to the grid elements of the reference grid that overlap the vector object.

The method can be used (in particular in conjunction with a GPS tracker or aerial image evaluations) to quickly and easily capture and document the status of areas or sections of areas for military, police and other official applications.

According to a further advantageous embodiment of the method, it is provided that
the vector object is a polygon vector object with at least three support points,
the grid elements are determined and selected according to step C) by determining and selecting those grid elements which lie completely within the polygon vector object (internal grid elements), and
the assigning of the object attribute linked to the vector object and/or a further attribute to the selected grid elements according to step D) is done by assigning the object attribute linked to the polygon vector object and/or the further attribute to the internal grid elements selected in the preceding step.

A polygon vector object describes a polygon whose support points are each connected to two other support points of the polygon by two polygon edges.

A grid element lies completely within a polygon vector object and is therefore an internal grid element if the grid element extends completely within the polygon edges of the vector object with respect to the reference coordinate system. An internal grid element with respect to the polygon is always also a grid element overlapping the polygon within the meaning of the present application.

Furthermore, the method may additionally comprise the following steps
E) determining and selecting those grid elements of the first grid width which overlap with the polygon vector object and at the same time do not lie completely within the polygon vector object (encompassing grid elements), and
F) assigning an edge attribute linked to the polygon vector object to the grid elements of the first grid width selected in step E).

In order to subsequently increase the capturing accuracy of the reference grid, the method can advantageously comprise the following steps
providing grid elements of a smaller grid width (child grid element) within the global reference grid, wherein the smaller grid width is smaller than the first grid width and a plurality of grid elements of the smaller grid width (child grid elements) is assigned to a grid element of the first grid width (parent grid element) in a uniquely identifiable and georeferenced manner and fills the latter completely and without overlap,
selecting a grid element of the first grid width (parent grid element) to which the first object attribute is assigned, and
selecting a grid element of the smaller grid width (child grid element) assigned to the selected grid element of the first grid width (parent grid element), assigning a second further attribute to the selected grid element of the smaller grid width and storing the selected grid element of the smaller grid width together with the linked second further attribute.

In this way, further attributes can be assigned to a sub-area of a grid element of the first grid width. This allows the grid to be refined or the resolution of the grid to be increased. The unambiguous assignment of the child grid elements to their respective parent grid element means that the content and spatially correct assignment of the information is retained. This refinement of the grid is also referred to as “drill-down”. The fact that the grid can only be refined selectively where high-resolution information needs to be captured—and not across the entire reference grid-means that memory space can be used very efficiently.

It may be intended that the child grid elements adopt the assigned (object) attributes of their parent grid elements.

Based on the method described herein, conflicts in the use of space (or volume) can be easily identified by means of the method for outputting a conflict message within a GIS application or a BIM application. The method comprises the following steps
assigning a first object attribute to a first selection, determined by means of a first vector object, of uniquely identifiable grid elements of a global reference grid,
assigning a second object attribute to a second selection, determined by means of a second vector object, of uniquely identifiable grid elements of the global reference grid,
selecting those grid elements (of the first grid width) to which both the first object attribute and the second object attribute are assigned by the processing unit, and
outputting a conflict message for the grid elements (of the first grid width) selected in the preceding step by the processor unit.

In this way, (usage) conflicts can be easily detected and corresponding warning messages issued by recognizing when both the first object attribute and the second object attribute are assigned to one and the same grid element of the reference grid.

Against this background, the method for outputting a conflict message can also be used in connection with so-called geo-fencing applications. For example, if a certain physical area in the reference coordinate system is to be marked as a restricted area, the first object attribute “restricted area” can be assigned to the associated grid elements overlapping the first vector object via a corresponding first vector object. A second vector object maps the position of a potential intruder on the physical surface in the reference coordinate system. According to the method, the second object attribute “position of the potential intruder” is assigned to those grid elements that overlap with a second vector object. If a grid element is now assigned both the first object attribute “restricted area” and the second object attribute “position of the potential intruder”, a conflict message can be outputted to indicate the intrusion of the intruder into the restricted area.

Furthermore, based on embodiments of the method described herein, an attribute (object attribute and/or further attribute) can be transferred from a first grid element to a second grid element by means of the method. The computer-implemented method for transferring an attribute from a first grid element to a second grid element of a global reference grid within a GIS application or a BIM application comprises the following steps
assigning an object attribute and/or a further attribute to a first selection, determined by means of a first vector object, of uniquely identifiable grid elements of a global reference grid,
selecting a first grid element of the first grid width to which the object attribute and/or the further attribute is assigned,
selecting a second grid element of the first grid width of the global reference grid, and
transferring the object attribute and/or the further attribute of the first grid element to the second grid element, in particular by
assigning the object attribute and/or the further attribute to the second grid element and storing the second grid element together with the assigned object attribute and/or the further attribute in the storage unit, and
deleting the assignment of the object attribute and/or the further attribute to the first grid element in the storage unit.

An attribute can be transferred from the first grid element to the second grid element by deleting the assignment of the attribute in the first grid element and assigning the attribute to the second grid element and storing it accordingly.

The attribute may be linked to time information indicating that the attribute is assigned to the first grid element up to a defined point in time and then to the second grid element. This time information together with the attribute information can be assigned to both grid elements accordingly so that it is traceable and documented when the attribute was transferred from where to where.

If the additional attribute designates, for example, a material type, its density and classification, the corresponding material flow can be followed in terms of time and space in this way. This is essential for the capturing, documentation and traceability of mass and volume flows (e.g. in connection with landfills or mines) and is becoming increasingly important in the context of the circular economy.

The captured data is consistent and easy to manage because the first and second grid elements are identically dimensioned due to the use of the global reference grid, and both grid elements are located in a common grid (or data space), so that cross-references can be easily established between the grid elements. None of this is possible in a conventional GIS application or BIM application.

In addition, the method for assigning an attribute to a grid element of a larger grid width of a global reference grid can be used to save even more storage space. For this purpose, the method for assigning an attribute to a grid element of a larger grid width of a global reference grid comprises the following steps:
assigning a first object attribute and/or a first further attribute to a first selection, determined by means of a first vector object, of uniquely identifiable grid elements of a first grid width of a global reference grid,
providing grid elements of a larger grid width within the global reference grid, wherein the larger grid width is larger than the first grid width and in each case a plurality of grid elements of the first grid width are assigned to a grid element of the larger grid width (parent grid element) in a uniquely identifiable and georeferenced manner and fill this grid element completely and without overlap,
selecting a grid element of the larger grid width (parent grid element), in which all the grid elements of the first grid width (14) assigned to it (i.e. all child grid elements) are each assigned the first object attribute and/or the first further attribute, and
assigning the first object attribute and/or the first further attribute to the grid element of the larger grid width selected in the preceding step and storing the selected grid element of the larger grid width together with the assigned object attribute and/or the first further attribute in the storage unit.

In this way, memory space can be saved in the storage unit. This is because the first attribute (object attribute and/or the further attribute) no longer has to be stored separately for each grid element of the first grid width (child grid element). Instead, it is sufficient if the first attribute is stored only once for the selected grid element of the larger grid width (parent grid element) and the convention is taken into account that an attribute assigned to the parent grid element is also deemed to be assigned to its child grid elements.

In addition, the invention may manifest itself in a system for data processing according and a computer program product.

The system for data processing is, in particular, a database management system that enables the capturing of the spatial arrangement of a physical object on a physical surface or in the physical space of a geographical reference coordinate system. The system for data processing can be designed in particular as a desktop computer, server (on-premise or in the cloud) or mobile device and comprises in particular a storage unit and a processor unit. The storage unit can be designed as a volatile or non-volatile data memory and enables the storage of data records and the provision of stored data records. The processor unit can be designed as one or more computer processors and enables, in particular, the processing, manipulation, determination, selection and assignment of data records and/or attributes.

### BRIEF DESCRIPTION OF THE DRAWING

The state of the art and examples of embodiments of the invention are explained in more detail below with reference to the drawing. In the drawings:

FIG. 1 shows the generation of a grid for a polygon vector object according to the prior art,

FIG. 2 shows a reference coordinate system with a reference point and a reference grid including grid elements,

FIG. 3 shows grid elements of a global reference grid, which are selected according to a method according to the invention and to which an object attribute can be assigned,

FIGS. 4A-4D show grid elements of a larger grid width and grid elements of the first grid width, which are provided in a method according to the invention,

FIGS. 5A-5D show grid elements of a first grid width and the associated grid elements of a smaller grid width, which are provided in a method according to the invention,

FIGS. 6A-6B show overlapping grid elements (in FIG. 6A) and internal grid elements (in FIG. 6B) of a reference grid, which are selected by a method according to the invention,

FIG. 7 shows internal grid elements of a first grid width and grid elements of a larger grid width, which together fill a polygon vector object and are provided in a method according to the invention.

### DETAILED DESCRIPTION OF THE PREFERRED EMBODIMENTS

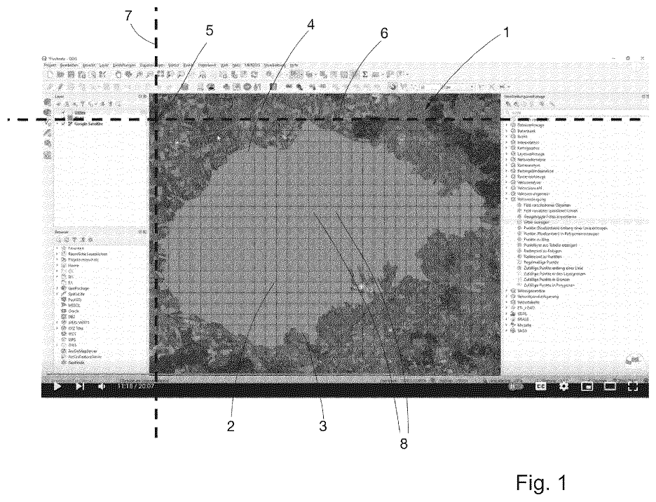

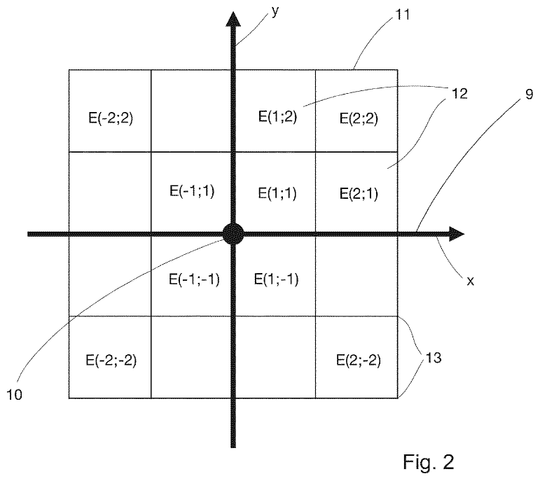

As already explained above, FIG. 1 shows the grid 4 as it is generated for the polygon vector object 3 according to the methods commonly used in the prior art, and FIG. 2 shows a reference coordinate system 9 with a reference point 10 and a reference grid 11.

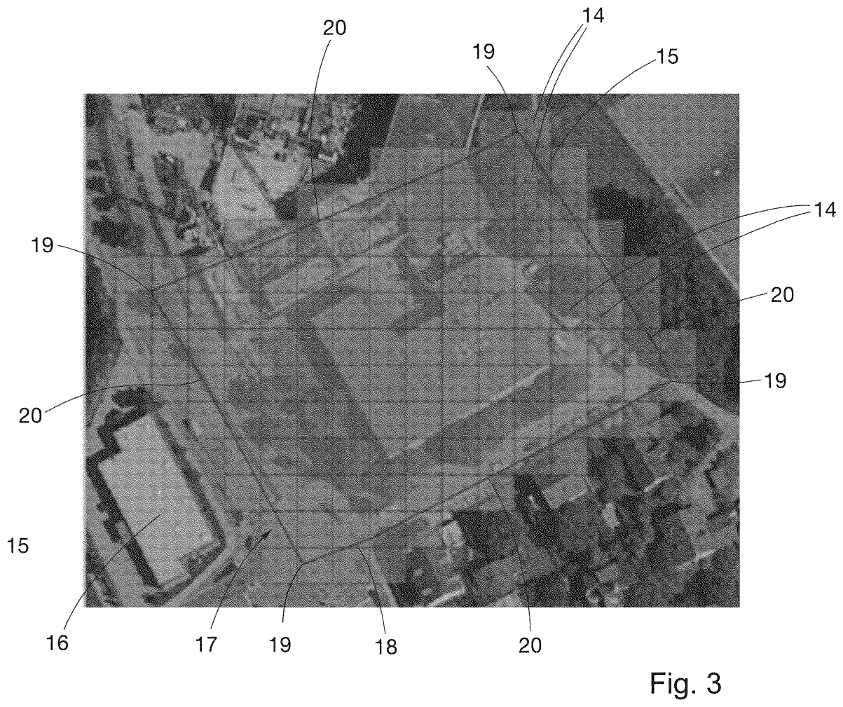

FIGS. 3 to 7 each illustrate grid elements 14 of a georeferenced global reference grid 15, as provided in the context of a method according to the invention. The following explanations are intended to further explain the method according to the invention using specific application examples.

FIG. 3 shows a section of a second map 16 georeferenced in a reference coordinate system, in the center of which a plot of property 17 with several buildings is arranged. The contour of the plot of property 17 is designed as a polygon vector object 18 georeferenced in the reference coordinate system. The polygon vector object 18 has several support points 19, which are connected by polygon edges 20 and thus describe the contour of the property 17. The support points 19 are each assigned a geographical coordinate of the reference coordinate system. Together, the support points 19 represent the position of the object “property” 17 in the geographic reference coordinate system.

Furthermore, a section of the georeferenced global reference grid 15 is shown with a selection of the grid elements 14 of a first grid width. The individual grid elements 14 of a first grid width (10 m×10 m) are each formed as a quadrangular polygon (or square), are adjacent to each other, can be uniquely identified within the global reference grid 15 by their designation and are georeferenced with respect to the reference coordinate system. FIG. 3 shows the selection of grid elements 14 of the first grid width that overlap with the polygon vector object 18 (with respect to their respective position in the reference coordinate system).

The grid elements 14 of the first selection have also been assigned the object attribute “property”, which is linked to the polygon vector object 18. The grid elements 14 of the first selection are then stored in a storage unit together with the “property” object attribute assigned to each of them.

EPSG:3035 is used as the reference coordinate system in the present example, although other suitable reference coordinate systems such as EPSG:3395 could also be used in an analogous manner. In this example, the starting point, base point or zero point of the reference coordinate system EPSG:3035 is used as the vector-object-independent defined geographical global reference point of the reference grid, which in turn is uniquely georeferenced globally by its longitude and latitude. EPSG (European Petrol Search Group) is a standard for the codification of coordinate reference systems.

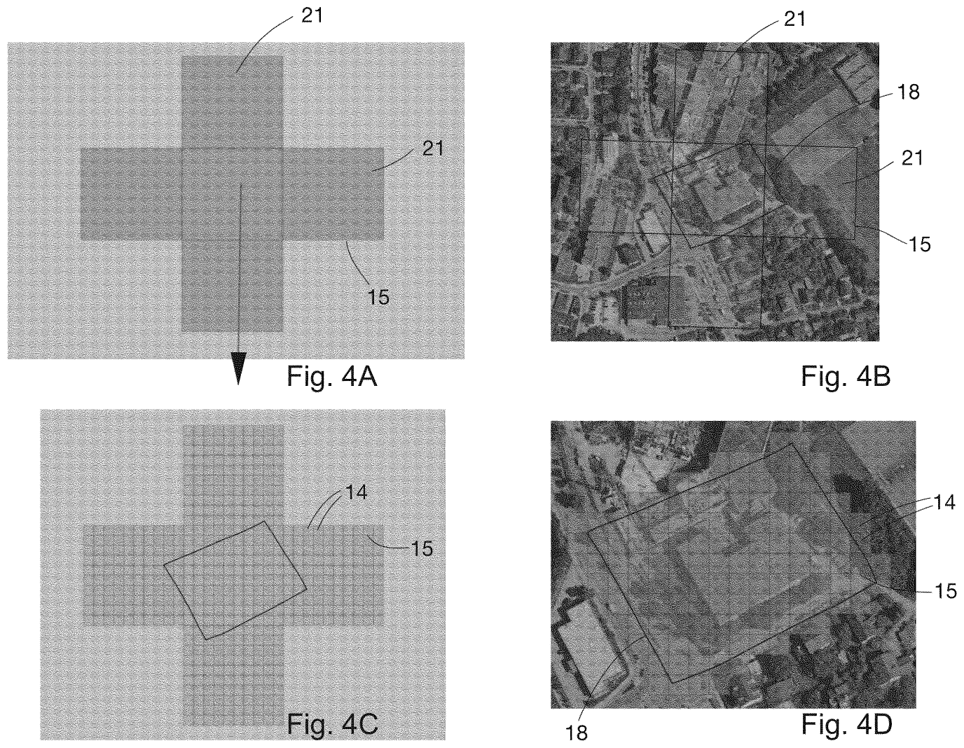

FIGS. 4A to 4D illustrate how the determination and selection of those grid elements of the first grid width 14 can be carried out particularly efficiently according to a preferred embodiment of the invention. In addition to the grid elements of the first grid width 14 (grid width 10 m×10 m), the reference grid 15 also has uniquely identifiable and georeferenced grid elements of a larger grid width 21 (grid width 100 m×100 m). A plurality of grid elements of the first grid width 14 are each uniquely identifiable and georeferenced to a grid element of the larger grid width 21 and fill this grid element of the larger grid width completely and without overlapping.

The grid elements of the first grid width 14 are thus in a kind of child-parent relationship to the grid elements of the larger grid width 21. Against this background, the grid elements of the larger grid width 21 are referred to as parent grid elements and the grid elements of the first grid width 14 as child grid elements (in the present interaction of the grid elements of different grid widths).

In order to determine which grid elements of the first grid width 14 overlap with the polygon vector object 18, those grid elements of the larger grid width 21 which overlap with the polygon vector object 18 are first determined and selected (cf. FIGS. 4A and 4B). Then those grid elements of the first grid width 14 that lie within the selected grid elements of the larger grid width 21 are activated (cf. FIG. 4C). The activated grid elements of the first grid width are then checked to see whether they overlap with the polygon vector object 18 and those grid elements of the first grid width which fulfill this condition are determined and selected. The selected grid elements of the first grid width 14 of this first selection are then assigned the object attribute “property” as already explained above.

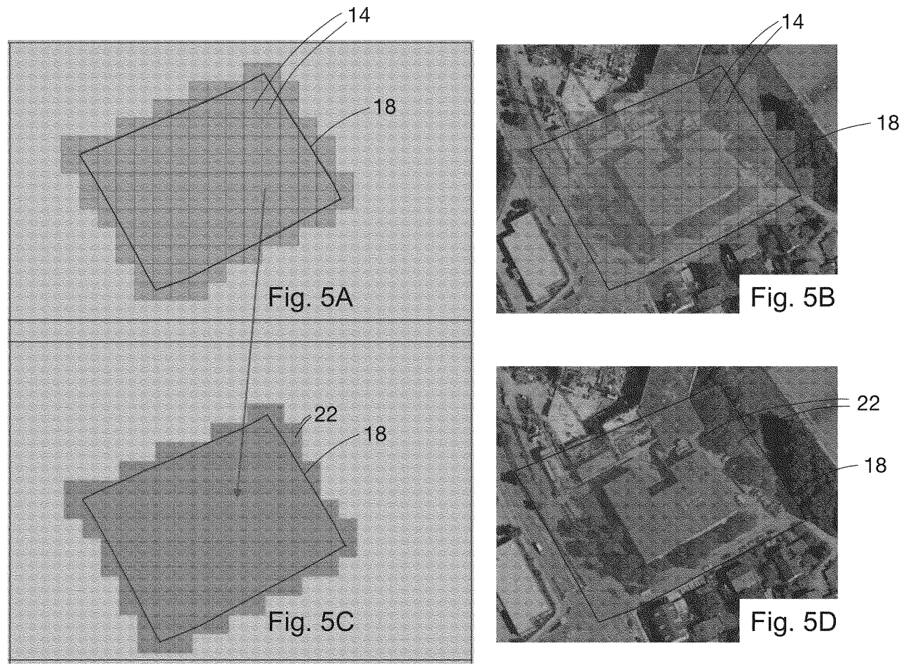

FIGS. 5A to 5D each illustrate grid elements of a first grid width 14 and the associated grid elements of a smaller grid width 22, which are provided in a method according to the invention. The quadrangular, square grid elements of the first grid width 14 function here as the larger parent grid elements and each have a grid width of 10 m×10 m. The grid elements of the smaller grid width 22 function here as the smaller child grid elements and each have a grid width of 1 m×1 m. In each case, 100 grid elements of the smaller grid width 22 (child grid elements) are uniquely identifiable and georeferenced to one of the grid elements of the first grid width 14 (parent grid element) and fill the respective grid elements of the first grid width 14 (parent grid element) completely and without overlap.

FIG. 5C shows those child grid elements which are assigned to the parent grid elements shown in FIGS. 5A and 5B. FIG. 5D, on the other hand, shows only that (second) selection of child grid elements (grid elements of the smaller grid width 22) which overlap with the polygon vector object 18. The children grid elements of the second selection can each be assigned the object attribute of their parent grid element and/or a second further attribute. The selected grid elements of the smaller grid width 22 that overlap with the polygon vector object 18 (see FIG. 5D) can thus be assigned the object attribute “property”, for example.

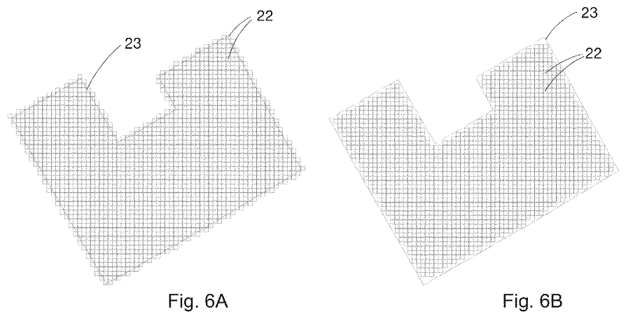

FIGS. 6A and 6B each show for a different polygon vector object 23, which represents the floor plan of the main building on the property 17 and is georeferenced accordingly, grid elements of the smaller grid width 22 that overlap with the associated polygon (FIG. 6A) or internal grid elements of the smaller grid width 22 that are placed within the associated polygon (FIG. 6B).

The internal grid elements 22 of the smaller grid width 22 have in common that they extend completely within the polygon edges of the polygon of the polygon vector object 23. The object attribute “building” was assigned to this selection of internal grid elements.

The grid elements of FIGS. 6A and 6B and the grid elements of FIGS. 3 to 5 are each a part of the (same) single global reference grid 15.

The grid elements of the smaller grid width 22 of FIGS. 6A and 6B are a subset of the grid elements 22 of the smaller grid width shown in FIGS. 5C and 5D.

If the grid elements of the smaller grid width 22 shown in FIG. 5D, which overlap the polygon vector object 18 (property), are each assigned the object attribute “property” and the internal grid elements of the smaller grid width 22 shown in FIG. 6B, which lie within the polygon vector object 23 (“building”), are each assigned the object attribute “building”, then both object attributes (“building” and “property”) are assigned to these internal grid elements. Thus, two different, independent grids are not generated for the two polygon vector objects (as is usual in the prior art) and different attributes are not stored in different grids. According to embodiments of the invention, (polygon) vector objects are captured by assigning attributes to grid elements of a single common reference grid 15.

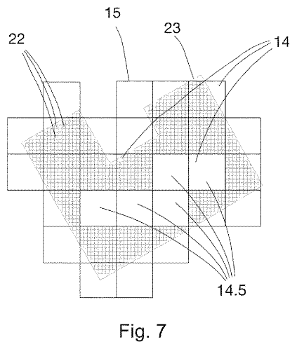

FIG. 7 illustrates how memory space can be saved by assigning an attribute to a grid element of a larger grid width. FIG. 7 shows the polygon vector object 23 with grid elements of the first grid width 14 (grid width 10 m×10 m) of the global reference grid 15. One hundred grid elements of the smaller grid width 22 (grid width 1 m×1 m) are uniquely identifiable and georeferenced to each grid element of the first grid width 14 and fill it completely and without overlap. In FIG. 7 (analogous to FIG. 6B), only the internal grid elements of the smaller grid width 22 are shown in relation to the polygon vector object 23.

Those five grid elements 14.5 of the first grid width whose one hundred grid elements of the smaller grid width 22 are all on the inside with respect to the polygon vector object 23 and to each of which the object attribute “building” is assigned were selected. The object attribute “building” was assigned to each of these five selected grid elements 14.5 of the first grid width and the five grid elements 14.5 were stored in the storage unit together with the respective assigned object attribute “building”.

Instead of storing the object attribute “building” 500 times together with 500 grid elements of the smaller grid width 22, it is now sufficient if the object attribute “building” is stored only five times together with the selected five grid elements 14.5 of the first grid width (parent grid element) and the convention is taken into account that an attribute assigned to the grid element of the first grid width 14 is also considered to be assigned to its one hundred grid elements of the smaller grid width 22. In this way, the memory space required in the storage unit can be reduced by a factor of 100.

In connection with FIG. 7, the grid elements of the first grid width 14 (grid width 10 m×10 m) are grid elements of a larger grid width compared to the smaller grid width 22 (grid width 1 m×1 m).

### LIST OF REFERENCE SYMBOLS

First map 1
Lake 2
Polygon vector object 3, 18, 23
Grid 4
Reference point 5
Horizontal straight line 6
Vertical straight line 7
Grid element 8
Reference coordinate system 9
x-axis x
y-axis y
Reference point 10
Reference grid 11
Grid elements 12
Corner point 13
Grid element of a first grid width 14
Reference grid 15
Second map 16
Plot 17
Support point 19
Polygon edge 20
Grid elements of a larger grid width 21
Grid elements of a smaller grid width 22

What is claimed is:

1. A computer-implemented method for capturing a spatial arrangement of a physical object on a physical surface or in physical space within a geographic reference coordinate system by assigning an object attribute and/or further attribute to a selection of uniquely identifiable global grid elements of a global reference grid (15) determined by means of a vector object, in particular within a database of a GIS application, a BIM application or a machine control application, comprising the following steps:
A) providing the global reference grid (11, 15), georeferenced with respect to the geographic reference coordinate system (9), with a geographic global reference point (10) defined independently of the vector object and global grid elements of a first grid width (14), which are each formed as a polygon or as a polyhedron, adjoin one another without overlapping and are uniquely identifiable within the global reference grid (11, 15) and are georeferenced with respect to the reference coordinate system (9), in a storage unit,
B) providing the vector object with at least one support point (19), to which a geographical coordinate of the geographical reference coordinate system (9) is assigned in each case and which represents the position of an object in the geographical reference coordinate system (9), in the storage unit,
C) determining and selecting those global grid elements of the first grid width (14) which overlap with the vector object by means of a processor unit, and
D) assigning an object attribute linked to the vector object and/or a further attribute to the global grid elements of the first grid width (14) selected in step C) by the processor unit and storing the selected global grid elements (14) together with the respectively assigned object attribute and/or the further attribute in the storage unit.

2. The method of claim 1, wherein:
a route for a mobile machine is determinable which leads, in particular exclusively, through surface areas or volume areas of the reference coordinate system which are represented by one of the global grid elements (14) stored together with the respectively assigned object attribute and/or the further attribute, the route is transmittable to the mobile machine and the route is followable by the mobile machine,
a route for a mobile machine is determinable which leads to a surface area or volume area of the reference coordinate system which is represented by one of the global grid elements (14) stored together with the respectively assigned object attribute and/or the further attribute, the route is transmittable to the mobile machine and the route is followable by the mobile machine, and/or
an alarm signal is triggerable when a mobile machine is located in a surface area or volume area of the reference coordinate system which is represented by one of the global grid elements (14) stored together with the respectively assigned object attribute and/or the further attribute.

3. The method of claim 1, wherein:
the georeferenced global reference grid (11, 15) comprises grid elements of the first grid width (14) and grid elements of a larger grid width (21),
the larger grid width (21) is larger than the first grid width (14) and in each case a plurality of grid elements of the first grid width (14) is assigned to a grid element of the larger grid width (21) in a uniquely identifiable and georeferenced manner and fills this grid element completely and without overlap, and
the method step C) of determining and selecting those grid elements of the first grid width (14) which overlap with the vector object comprises:
determining and selecting those grid elements of the larger grid width (21) which overlap with the vector object,
activating the grid elements of the first grid width (14) which lie within a grid element of the larger grid width (21) selected in the preceding step, and
determining and selecting those grid elements of the first grid width (14) activated in the preceding step which overlap with the vector object.

4. The method of claim 1, wherein the at least one further attribute is formed as:
a main object attribute which assigns a superordinate main object to a grid element, in particular a building, a story, a part of a building, a building section and/or a room,
an area attribute that assigns an area name, an area type, an area status, in particular the area status “to be cleared”, “cleared and safe”, “ready for dismantling”, “ready to receive”, “free”, and/or an area type to a grid element,
a sub-object attribute that assigns a downstream sub-object to a grid element,
a qualitative or quantitative attribute that assigns a color, a material, a floor type and/or a floor covering type to a grid element,
a temporal or statistical attribute that assigns a time and/or an object number to a grid element, in particular to enable the tracking of moving objects such as vehicles,
a complex attribute that assigns a document, in particular a soil survey, a laboratory analysis or an aerial photograph, and/or a data set, in particular a table, to a grid element, and/or
a link attribute that assigns a link to a grid element.

5. The method of claim 1, wherein the vector object is provided by assigning the geographic coordinate of the reference coordinate system (9) to the at least one support point (19) by means of a GPS tracker.

6. The method of claim 1, wherein:
the vector object is a polygon vector object (3, 18, 23) with at least three support points (19),
the grid elements are determined and selected according to step C) by determining and selecting those grid elements which lie completely within the polygon vector object (3, 18, 23) (internal grid elements), and
the assigning of the object attribute linked to the vector object and/or a further attribute to the selected grid elements according to step D) is done by assigning the object attribute linked to the polygon vector object (3, 18, 23) and/or the further attribute to the internal grid elements selected in the preceding step.

7. The method of claim 5 further comprising:
E) determining and selecting those grid elements of the first grid width (14) which overlap with the polygon vector object (3, 18, 23) and at the same time do not lie completely within the polygon vector object (3, 18, 23) (encompassing grid elements), and
F) assigning an edge attribute linked to the polygon vector object (3, 18, 23) to the grid elements of the first grid width (14) selected in step E).

8. The method of claim 1 further comprising:
providing grid elements of a smaller grid width (22) within the global reference grid, wherein the smaller grid width (22) is smaller than the first grid width (14) and in each case a plurality of grid elements of the smaller grid width (22) is assigned to a grid element of the first grid width (14) in a uniquely identifiable and georeferenced manner and fills the latter completely and without overlap,
selecting a grid element of the first grid width (14) to which the first object attribute is assigned, and
selecting a grid element of the smaller grid width (22) assigned to the selected grid element of the first grid width (14), assigning a second further attribute to the selected grid element of the smaller grid width (22) and storing the selected grid element of the smaller grid width (22) together with the linked second further attribute.

9. The method of claim 1, wherein:
the grid elements are uniquely identifiable by a unique grid element designation, and
the coordinates of the corner points of the respective grid element are determinable from the grid element designation,
the size of the grid element are derivable from the grid element designation, and/or
an assignment to a higher-level parent grid element with a larger grid width is derivable from the grid element designation.

10. A computer-implemented method for outputting a conflict message, in particular within a GIS application, a BIM application or a machine control application, comprising the following steps:
assigning a first object attribute to a first selection, determined by means of a first vector object, of uniquely identifiable grid elements (14) of a global reference grid (11, 15) according to claim 1,
assigning a second object attribute to a second selection, determined by means of a second vector object, of uniquely identifiable grid elements (14) of the global reference grid (11, 15),
selecting those grid elements to which both the first object attribute and the second object attribute are assigned by the processing unit, and
outputting a conflict message for the grid elements selected in the preceding step by the processing unit.

11. A computer-implemented method for transferring an attribute from a first grid element (14) to a second grid element (14) of a global reference grid (11, 15), in particular within a GIS application, a BIM application or a machine control application, comprising the following steps:
assigning an object attribute and/or a further attribute to a first selection, determined by means of a first vector object, of uniquely identifiable grid elements (14) of a global reference grid (11, 15) according to claim 1,
selecting a first grid element of the first grid width (14) to which the object attribute and/or the further attribute is assigned,
selecting a second grid element of the first grid width (14) of the global reference grid (11, 15), and
transferring the object attribute and/or the further attribute of the first grid element to the second grid element, in particular by
assigning the object attribute and/or the further attribute to the second grid element and storing the second grid element together with the assigned object attribute and/or the further attribute in the storage unit, and
deleting the assignment of the object attribute and/or the further attribute to the first grid element in the storage unit.

12. A computer-implemented method for assigning an attribute to a grid element of a larger grid width (21) of a global reference grid (11, 15), comprising the following steps:
assigning a first object attribute and/or a first further attribute to a first selection, determined by means of a first vector object, of uniquely identifiable grid elements of a first grid width (14) of a global reference grid (11, 15) according to claim 1,
providing grid elements of a larger grid width (21) within the global reference grid (11, 15), the larger grid width (21) being larger than the first grid width (14) and in each case a plurality of grid elements of the first grid width (14) being uniquely identifiable and georeferenced to a grid element of the larger grid width (21) and fill the latter completely and without overlap,
selecting a grid element of the larger grid width (21), in which all the grid elements of the first grid width (14) assigned to it are each assigned the first object attribute and/or the first further attribute, and
assigning the first object attribute and/or the first further attribute to the grid element of the larger grid width (21) selected in the preceding step and storing the selected grid element of the larger grid width (21) together with the assigned object attribute and/or the first further attribute in the storage unit.

13. A system for data processing, comprising means, in particular a storage unit and a processor unit, for carrying out the steps of the method according to claim 1.

14. A non-transitory computer program product comprising instructions which, when the computer program product is executed by a computer, cause the computer to perform the steps of the method of claim 1.
